(19) United States
(12) Patent Application Publication
(10) Pub. No.: US 2009/0243947 A1
(43) Pub. Date: Oct. 1, 2009

(54) Antenna With First and Second Loop Radiating Elements

(75) Inventors: Tiao-Hsing Tsai, Yungho City (TW); Chih-Wei Liao, Su-ao Township (TW); Chao-Hsu Wu, Lu Chu Hsiang (TW)

Correspondence Address: Sunstein Kann Murphy & Timbers LLP, 125 SUMMER STREET, BOSTON, MA, 02110-1618, US

(73) Assignee: QUANTA COMPUTER INC., Kuei Shan Hsiang (TW)

(21) Appl. No.: 12/174,760

(22) Filed: Jul. 17, 2008

(30) Foreign Application Priority Data
Apr. 1, 2008 (TW) 097111856

(51) Int. Cl. H01Q 11/12; H01Q 1/38

(52) U.S. Cl. 343/742; 343/700 MS

(57) ABSTRACT

An antenna includes a dielectric substrate, first and second feeding points, first and second grounding points, first and second loop radiating elements, and a grounding element. The first and second feeding points and the first and second grounding points are formed on the dielectric substrate. The first and second radiating elements are spaced apart from each other and have a shape and a size that are identical. Each of the first and second loop radiating elements is operable in a frequency range, and has a feeding end coupled to a respective one of the first and second feeding points, and a grounding end coupled to a respective one of the first and second grounding points. The grounding element is formed on the dielectric substrate and is disposed between the first and second loop radiating elements.

### CROSS-REFERENCE TO RELATED APPLICATION

This application claims priority of Taiwanese application no. 097111856, filed on Apr. 1, 2008.

### BACKGROUND OF THE INVENTION

1. Field of the Invention

This invention relates to an antenna, more particularly to an antenna that is applicable to worldwide interoperability for microwave access (WiMAX).

2. Description of the Related Art

Worldwide interoperability for microwave access (WiMAX) technology is undergoing rapid development.

It is therefore desirable to provide an antenna that is operable in the WiMAX frequency ranges from 2300 MHz to 2700 MHz and from 3300 MHz to 3800 MHz.

### SUMMARY OF THE INVENTION

According to the present invention, an antenna comprises a dielectric substrate, first and second feeding points, first and second grounding points, first and second loop radiating elements, and a grounding element. The first and second feeding points are formed on the dielectric substrate. The first and second grounding points are formed on the dielectric substrate. The first and second loop radiating elements are spaced apart from each other, and have a shape and a size that are identical. Each of the first and second loop radiating elements is operable in a frequency range, and has a feeding end coupled to a respective one of the first and second feeding points, and a grounding end coupled to a respective one of the first and second grounding points. The grounding element is formed on the dielectric substrate, and has an end portion disposed between the first and second loop radiating elements, thereby enhancing isolation between the first and second loop radiating elements.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an antenna according to this invention;

FIG. 2 is a perspective view illustrating first and second feeding points and first and second grounding points of the preferred embodiment;

FIG. 3 is a schematic view illustrating dimensions (in millimeters) of the preferred embodiment;

FIG. 4 is a plot illustrating a voltage standing wave ratio (VSWR) of each of first and second loop radiating elements of the preferred embodiment;

FIG. 5 shows plots of radiation patterns of the first and second loop radiating elements of the preferred embodiment when operated at 2500 MHz;

FIG. 6 shows plots of radiation patterns of the first and second loop radiating element of the preferred embodiment when operated at 3500 MHz;

FIG. 7 shows plots of radiation patterns of the first loop radiating element of the preferred embodiment respectively on the x-y, x-z, and y-z planes when operated at 2500 MHz;

FIG. 8 shows plots of radiation patterns of the second loop radiating element of the preferred embodiment respectively on the x-y, x-z, and y-z planes when operated at 2500 MHz;

FIG. 9 shows plots of radiation patterns of the first loop radiating element of the preferred embodiment respectively on the x-y, x-z, and y-z planes when operated at 3500 MHz; and

FIG. 10 shows plots of radiation patterns of the second loop radiating element of the preferred embodiment respectively on the x-y, x-z, and y-z planes when operated at 3500 MHz.

### DETAILED DESCRIPTION OF THE PREFERRED EMBODIMENT

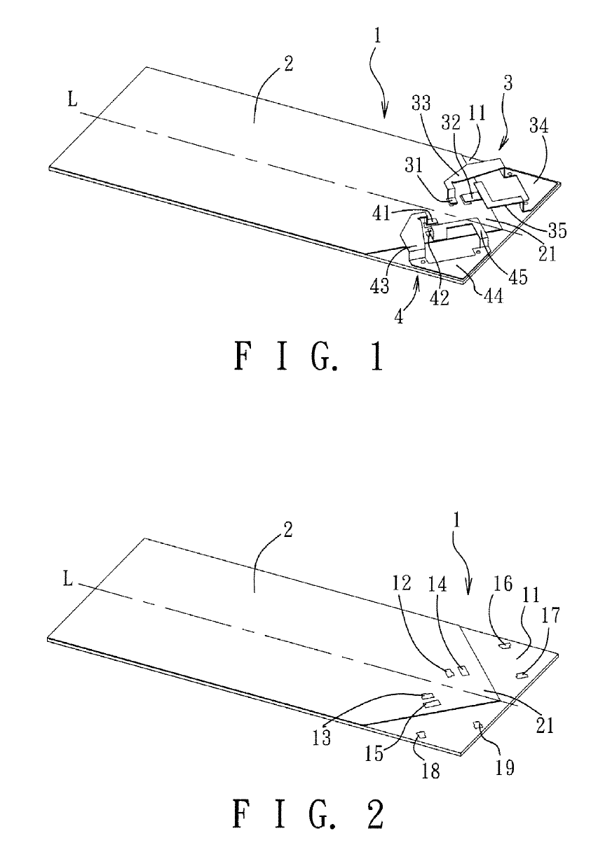

Referring to FIGS. 1 and 2, the preferred embodiment of an antenna according to this invention is shown to include a dielectric substrate 1, first and second feeding points 12, 13, first and second grounding points 14, 15, first and second loop radiating elements 3, 4, and a grounding element 2.

The antenna of this invention is applicable to a card, is applicable to a card, such as a PCMCIA card.

The dielectric substrate 1 is rectangular in shape and has a surface 11.

Each of the first and second feeding points 12, 13 and the first and second grounding points 14, 15 is formed on the surface 11 of the dielectric substrate 1.

The antenna further includes first, second, third, and fourth surface mount technique (SMT) pads 16, 17, 18, 19, each of which is formed on the surface 11 of the dielectric substrate 1, and plurality of conductive traces (not shown), each of which connects the first and second feeding points 12, 13 and the first and second grounding points 14, 15 to a transceiver circuit (not shown).

In this embodiment, the first feeding point 12, the first grounding point 14, and the first and second SMT pads 16, 17 are respectively symmetrical to the second feeding point 13, the second grounding point 15, and the third and fourth SMT pads 18, 19 with respect to an axis of symmetry (L).

The first and second loop radiating elements 3, 4 are spaced apart from each other and are symmetrical with respect to the axis of symmetry (L). In this embodiment, each of the first and second loop radiating elements 3, 4 is operable in a worldwide interoperability for microwave access (WiMAX) frequency range from 2300 MHz to 3800 MHz.

Furthermore, each of the first and second loop radiating elements 3, 4 has a feeding end 31, 41 coupled, i.e., soldered, to a respective one of the first and second feeding points 12, 13, and a grounding end 32, 42 coupled, i.e., soldered, to a respective one of the first and second grounding points 14, 15. In particular, the first loop radiating element 3 includes first, second, and third segments 33, 35, 34. The first segment 33 of the first loop radiating element 3 has a first end that defines the feeding end 31 of the first loop radiating element 3, a second end that is opposite to the first end thereof, and an intermediate portion that extends between the first and second ends thereof and that is spaced apart from the dielectric substrate 1. The second segment 35 of the first loop radiating element 3 has a first end that defines the grounding end 32 of the first loop radiating element 3, a second end that is opposite to the first end thereof, and an intermediate portion that extends between the first and second ends thereof and that is spaced apart from the dielectric substrate 1. The third segment 34 of the first loop radiating element 3 is coupled, i.e., soldered, to the first and second SMT pads 16, 17, and interconnects the second ends of the first and second segments 33, 35 of the first loop radiating element 3.

In this embodiment, each of the first and third segments 33, 34 of the first loop radiating element 3 has a physical size larger than that of the second segment 35 of the first loop radiating element 3. The construction as such facilitates impedance matching in a low frequency component of the WiMAX frequency range to thereby achieve a wide bandwidth and a high gain for the antenna of this invention. Moreover, in this embodiment, the first and second segments 33, 35 of the first loop radiating element 3 define a distance therebetween that may be adjusted to obtain an impedance match in a high frequency component of the WiMAX frequency range to thereby achieve a wide bandwidth and a high gain for the antenna of this invention. Further, in this embodiment, each of the first and third segments 33, 34 of the first loop radiating element 3 is generally triangular in shape. The construction as such permits a smooth flow of an antenna radiation current along the first loop radiating element 3, thereby reducing energy leakage of the antenna of this invention and minimizing an overlapping portion of the low and high frequency components of the WiMAX frequency range. This results in a wideband width effect for the antenna of this invention.

The second loop radiating element 4, like the first loop radiating element 3, includes first, second, and third segments 43, 45, 44. The first segment 43 of the second loop radiating element 4 has a first end that defines the feeding end 41 of the second loop radiating element 4, a second end that is opposite to the first end thereof, and an intermediate portion that extends between the first and second ends thereof and that is spaced apart from the dielectric substrate 1. The second segment 45 of the second loop radiating element 4 has a first end that defines the grounding end 42 of the second loop radiating element 4, a second end that is opposite to the first end thereof, and an intermediate portion that extends between the first and second ends thereof and that is spaced apart from the dielectric substrate 1. The third segment 44 of the second loop radiating element 4 is coupled, i.e., soldered, to the third and fourth SMT pads 18, 19, and interconnects the second ends of the first and second segments 43, 45 of the second loop radiating element 4.

In this embodiment, each of the first and second loop radiating elements 3, 4 has a length of one-half wavelength in the WiMAX frequency range.

It is noted that since the third segment 34 of the first loop radiating element 3 is soldered on the first and second SMT pads 16, 17, and since the third segment 44 of the second loop radiating element 4 is soldered on the third and fourth SMT pads 18, 19, the antenna of this invention has a strong structure.

The grounding element 2 is formed on the surface 11 of the dielectric substrate 1, has a tapered end portion 21 and that is disposed between the first and second loop radiating elements 3, 4, and surrounds the first and second feeding points 12, 13 and the first and second grounding points 14, 15.

In this embodiment, the first and second loop radiating elements 3, 4 are spaced apart in such a manner that the first segments 33, 43 of the first and second loop radiating elements 3, 4 are distal from each other and the second segments 35, 45 of the first and second loop radiating elements 3, 4 are proximate to each other. Moreover, in this embodiment, since the end portion 21 of grounding element 2 is disposed between the first and second loop radiating elements 3, 4, isolation between the first and second loop radiating elements 3, 4 is improved, and mutual interference between the first and second loop radiating elements 3, 4 is prevented.

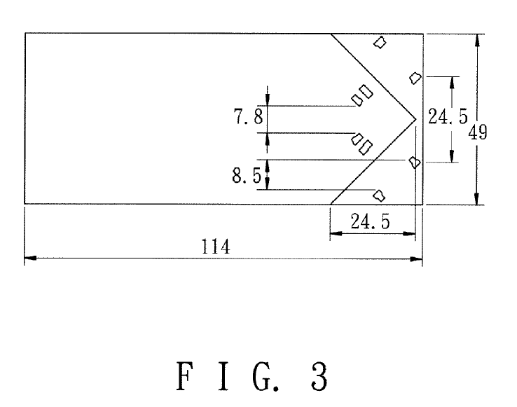

As evident in FIG. 3, the antenna of this invention has a small physical size.

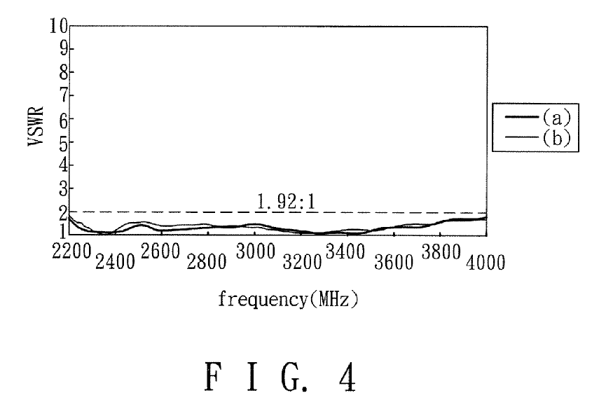

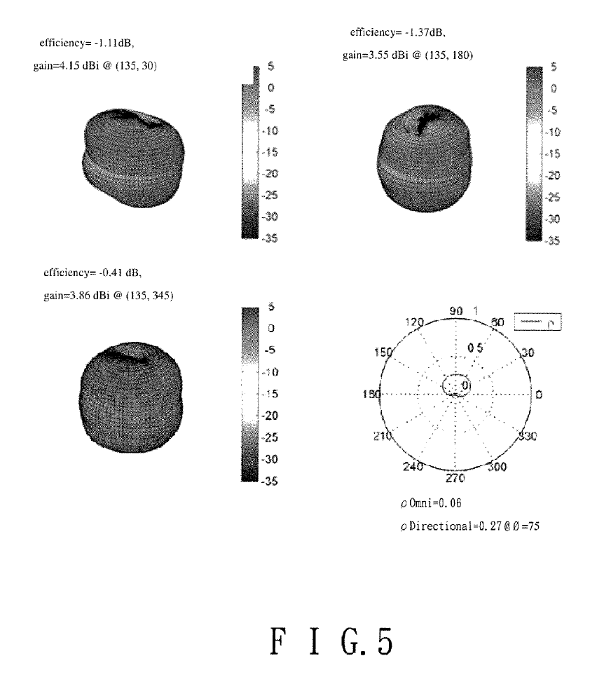

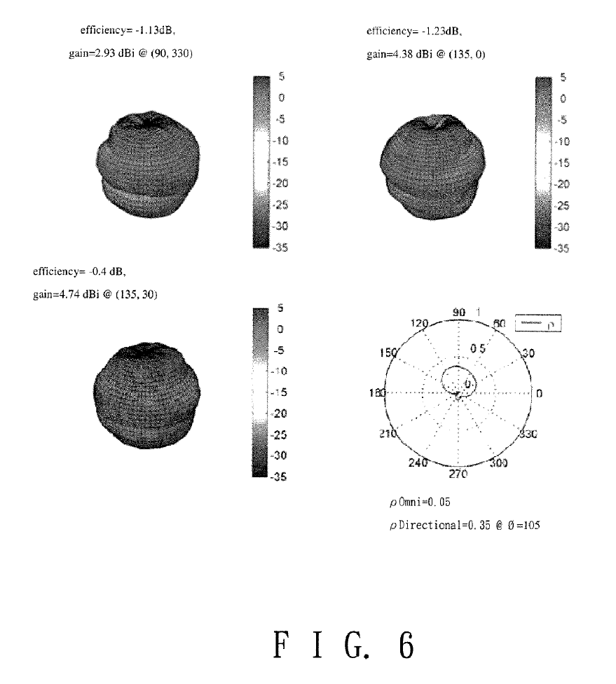

Experimental results, as illustrated in FIG. 4, show that each of the first loop radiating element 3, as indicated by line (a), and the second loop radiating element 4, as indicated by line (b), of the antenna of this invention achieves a voltage standing wave ratio (VSWR) of less than 2.0 when operated in the WiMAX frequency range. Moreover, when operated in the WiMAX frequency range, the antenna of this invention has a maximum isolation of 13.8 dB, as shown in Table I, a minimum envelop correlation coefficient (ECC) of 0.01, as shown in Table II, and satisfactory efficiencies and peak gains, as shown in Table III. Further, when the first and second loop radiating elements 3, 4 is operated at 2500 MHz, as shown in FIG. 5, and at 3500 MHz, as shown in FIG. 6, it is evident that the first and second loop radiating elements 3, 4 of the antenna of this invention are substantially independent from each other.

TABLE I

| | Frequency (MHz) | | | | | |
|---|---|---|---|---|---|---|
| | 2300 | 2500 | 2700 | 3300 | 3500 | 3800 |
| Isolation (dB) | 13.8 | 12.0 | 12.0 | 12.5 | 13.0 | 11.8 |

TABLE II

Frequency (MHz)

| | 2300 | 2500 | 2700 | 3300 | 3500 | 3800 |
|---|---|---|---|---|---|---|
| ECC | 0.05 | 0.06 | 0.10 | 0.06 | 0.05 | 0.01 |

TABLE III

| | |
|---|---|
| first loop | second loop |
| radiating | radiating |
| element | element |

| Frequency | Efficiency | Peak gain | Efficiency | Peak Gain |
|---|---|---|---|---|
| (MHz) | (dB) | (dBi) | (dB) | (dBi) |
| 2300 | −0.3 | 4.4 | −0.6 | 4.4 |
| 2400 | −0.8 | 3.9 | −1.1 | 4.5 |
| 2500 | −1.1 | 4.2 | −1.4 | 3.6 |
| 2600 | −1.2 | 4.2 | −1.4 | 3.6 |
| 2700 | −1.0 | 4.7 | −1.2 | 4.3 |
| 3300 | −1.2 | 3.6 | −1.8 | 4.4 |
| 3400 | −1.2 | 3.3 | −1.4 | 4.2 |
| 3500 | −1.1 | 3.1 | −1.2 | 4.4 |
| 3600 | −0.6 | 3.3 | −1.1 | 3.9 |
| 3700 | −1.0 | 3.2 | −1.4 | 4.1 |
| 3800 | −1.1 | 3.2 | −1.5 | 3.2 |

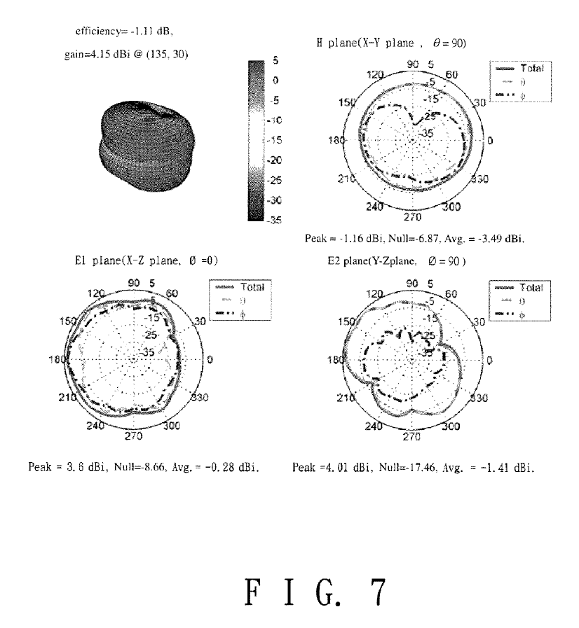

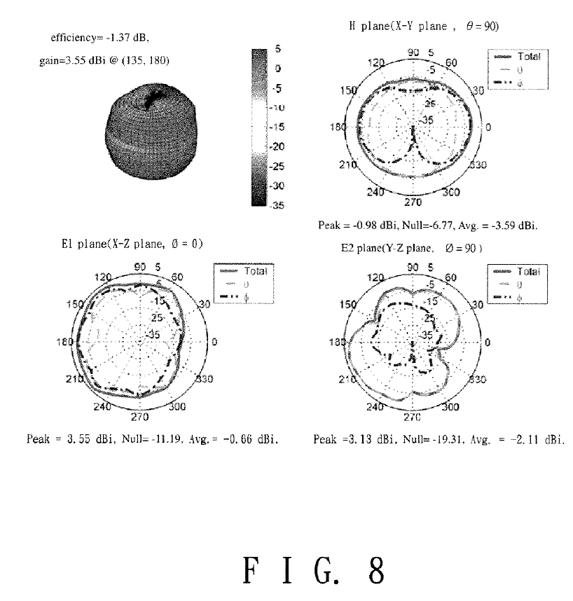

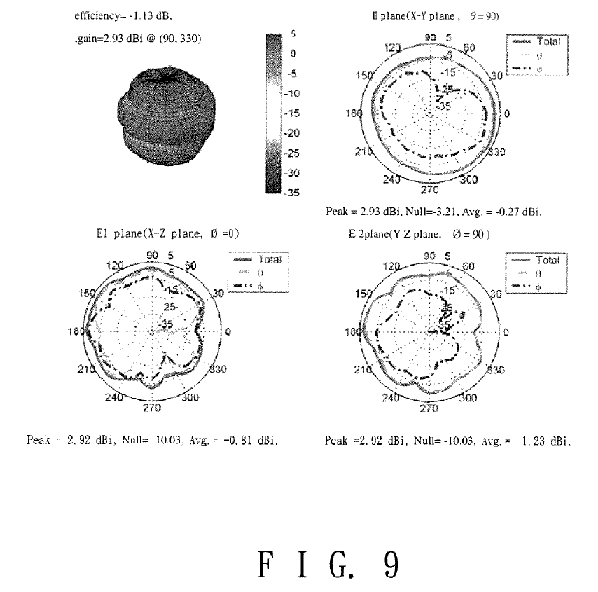

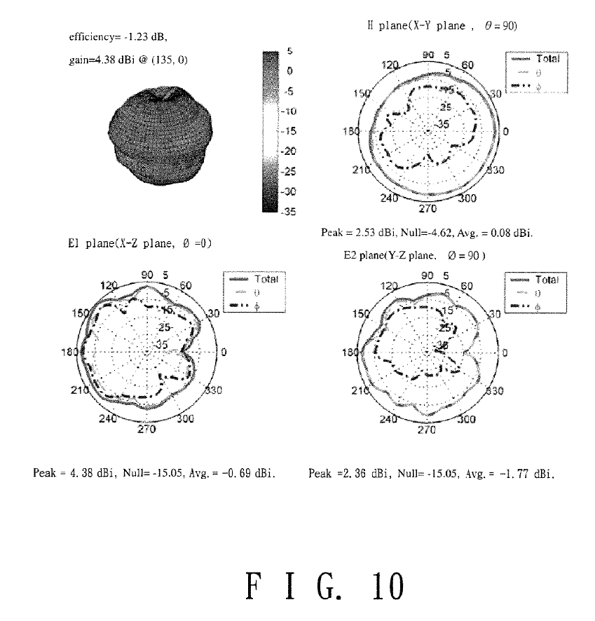

Furthermore, as illustrated in FIGS. 7 and 8, the first loop radiating element 3 has radiation patterns that complement those of the second loop radiating element 4 when each of the first and second radiating elements 3, 4 is operated at 2500 MHz, and as illustrated in FIGS. 9 and 10, the first loop radiating element 3 has radiation patterns that complement those of the second loop radiating element 4 when each of the first and second radiating elements 3, 4 is operated at 3500 MHz. It is therefore apparent that the antenna of this invention has a diversity effect that significantly reduces the susceptibility thereof to multi-path influence, and thus, an increase in the efficiency thereof is achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna comprising:
a dielectric substrate;
first and second feeding points formed on said dielectric substrate;
first and second grounding points formed on said dielectric substrate;
first and second loop radiating elements spaced apart from each other, and having a shape and a size that are identical, each of said first and second loop radiating elements being operable in a frequency range, and having a feeding end coupled to a respective one of said first and second feeding points, and a grounding end coupled to a respective one of said first and second grounding points; and
a grounding element formed on said dielectric substrate, and having an end portion disposed between said first and second loop radiating elements, thereby enhancing isolation between said first and second loop radiating elements.

2. The antenna as claimed in claim 1, wherein said first loop radiating element has a portion that is spaced apart from said dielectric substrate.

3. The antenna as claimed in claim 1, wherein said first and second loop radiating elements are symmetrical with respect to an axis of symmetry.

4. The antenna as claimed in claim 1, wherein said first loop radiating element includes
a first segment that has opposite first and second ends, said first end of said first segment of said first loop radiating element defining said feeding end of said first loop radiating element,
a second segment that has opposite first and second ends, said first end of said second segment of said first loop radiating element defining said grounding end of said first loop radiating element, and
a third segment that interconnects said second ends of said first and second segments thereof.

5. The antenna as claimed in claim 4, wherein said first segment of said first loop radiating element further has an intermediate portion that extends between said first and second ends thereof and that is spaced apart from said dielectric substrate.

6. The antenna as claimed in claim 4, wherein said second segment of said first loop radiating element further has an intermediate portion that extends between said first and second ends thereof and that is spaced apart from said dielectric substrate.

7. The antenna as claimed in claim 4, wherein said third segment of said first loop radiating element is mounted on said dielectric substrate.

8. The antenna as claimed in claim 4, wherein at least one of said first and third segments of said first loop radiating element has a physical size larger than that of said second segment of said first loop radiating element.

9. The antenna as claimed in claim 4, wherein at least one of said first and third segments of said first loop radiating element has a triangular shape.

10. The antenna as claimed in claim 1, wherein said first loop radiating element has a length of one-half wavelength in the frequency range.

11. The antenna as claimed in claim 1, wherein the frequency range covers frequencies from 2300 MHz to 3800 MHz.

12. The antenna as claimed in claim 1, wherein said grounding element surrounds said first and second feeding points and said first and second grounding points.
